(19) United States
(12) Patent Application Publication
(10) Pub. No.: US 2010/0174775 A1
(43) Pub. Date: Jul. 8, 2010

(54) COMMUNICATION APPARATUS, COMMUNICATION METHOD AND COMPUTER-READABLE STORAGE MEDIUM

(75) Inventor: Kohji Saiki, Kawasaki-Shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/561,438

(22) Filed: Sep. 17, 2009

(30) Foreign Application Priority Data
Jan. 7, 2009 (JP) 2009-1541

(51) Int. Cl. G06F 15/16

(52) U.S. Cl. 709/203

(57) ABSTRACT

There is provided a communication apparatus including: a request transmission unit configured to transmit a request based on the acquisition request of the content position information indicating the position of the contents on a network; a response processing rule storage unit configured to store the response processing rule defining the process for the response; and a response receiving unit configured to receive the response corresponding to the request, search the response processing rule storage unit based on the received response, detect the process corresponding to the received response in accordance with the response processing rule, execute one of the processes including the continuation of the redirect operation, the stoppage of the redirect operation and the generation of a new request as the detected process, and in the case where the redirect operation is stopped, acquire the content position information from the received response and transmit it.

### CROSS REFERENCE TO RELATED APPLICATION

This application is based upon and claims benefit of priority from the Japanese Patent Application No. 2009-1541, filed on Jan. 7, 2009, the entire contents of which are incorporated herein by reference.

### BACKGROUND OF THE INVENTION

The present invention relates to a communication apparatus, a communication method and a computer-readable storage medium.

In a video-sharing site in which a video uploaded from a user is shared with other users, the videos picked up by users and company advertisements are shared and distributed. The contents of the video-sharing site are often distributed using the contents delivery network (CDN). Also, in the case where the video-sharing site is browsed with a web browser or the like and the contents are viewed on the web browser, only the contents are distributed to the video reproduction plug-in on the web browser through the CDN.

The CDN is a network for distributively arrange and distribute the contents such as images and music. For example, one content is duplicated and arranged in a plurality of different cache servers. The CDN, upon access thereto from a user, transmits the contents from a cache server which can transmit the contents to the user most efficiently from the viewpoint of the degree of concentration of accesses by the users in terms of the physical state and the network configuration. The same content, therefore, is not always transmitted from the same cache server, but may be transmitted from a different cache server depending on the user making access and the time zone or the area in which the access is made.

In the CDN, the period in which a specified user can view the same content with the same server is often limited. In the case where the same content is accessed repeatedly, therefore, the CDN assigns the access to another cache sever again. To realize this, the CDN controls a session. Since hypertext transfer protocol (HTTP) is often used for the content distribution, the CDN prevents a limitless access from the user by issuing a session ID with a deadline and distributing the contents only to requests having the session ID.

A HTTP function in which a client accessing a video-sharing site through a CDN is guided to another web server is a “redirect” operation (see, for example, HTTP1.1 RFC2068). The HTTP server has a status code in the order of 300 for the accessing HTTP client, and transmits a response designating the URL of the destination in a location header. The HTTP client who has received this response again accesses the URL described in the location header.

Normally, the HTTP client such as the web browser automatically accesses the redirect destination, and repeats the redirect operation until a response having the status code on other than the order of 300 is returned from the HTTP server.

In this way, the CDN automatically selects the cache server having a moderate processing load and located near the user physically in terms of the network configuration. As a result, the loads are prevented from being concentrated on one server, and the efficient distribution is made possible while at the same time shortening the user time to wait for the response from the server.

Even in the case where this system is used, however, there occurs a delay time from the content selection by the user before the content reproduction. This delay is caused, for example, by the time consumed to select an appropriate cache server to meet the request from the user and guide the user terminal to the cache server by the redirect operation.

The time required to redirect the client to the cache server includes the delay caused by the client-related process such as the selection of the cache server assigned to the request from the user by the load distribution function of the CDN and the name solution by the DNS used when the redirected client transmits the HTTP request again, and the delay of the network itself.

In order to keep the user unconscious of the reproduction delay in the CDN, a “prefetch” function has so far been widely incorporated in the content viewing application so that a part or the whole of the contents likely to be viewed by the user is downloaded and stored in advance.

The prefetch function, though effective in reducing the reproduction delay, requires the storage for holding a part or the whole of the content acquired in advance. In order to exhibit the prefetch function more effectively, a greater number of contents are required to be prefetched, and therefore, a correspondingly larger capacity of the storage is required.

In the case where the PC is used for viewing, a sufficient storage capacity can be secured and no special problem is posed by prefetching a large amount of contents. For the home electric appliances not equipped with a storage unit of a large capacity such as a hard disk and having no memory of more than the required minimum capacity, however, it is difficult to prefetch a large amount of contents.

### SUMMARY OF THE INVENTION

According to one aspect of the present invention, there is provided a communication apparatus comprising:

a first control unit configured to receive an acquisition request for content position information which describes the position of any one of a plurality of servers making up a content distribution network and holding the same content, the content position information indicating the position of a server distributing, and construct a request to notify the content position information to the server with the position thereof described in the acquisition request;

a request transmission unit configured to transmit the request constructed by the first control unit to the server with the position thereof described in the acquisition request;

a response receiving unit configured to receive a response including a status code which indicates a meaning of the response to the request transmitted from the server;

a rule storage unit configured to store a response processing rule specifying the correspondence between information described in the response and selected one of the retransmission of the request and the generation of the content position information as a process after response reception; and

a second control unit configured to detect, from the rule storage unit, a response processing rule corresponding to the information described in the response received by the response receiving unit, and in a case where the detected response processing rule is the retransmission of the request, notify the first control unit of selected one of a retransmission request for the request generated with a server different from the transmission destination as a retransmission destination and a retransmission request for the request carrying a different parameter for the same server as the transmission destination, while in a case where the detected response processing rule is the generation of the content position information, on the other hand, generate the content position information from the information described in the response and transmit the content position information to the transmitter of the acquisition request.

According to one aspect of the present invention, there is provided a communication method comprising:

receiving an acquisition request for content position information which describes the position of any one of a plurality of servers making up a content distribution network and holding the same content, the content position information indicating the position of the server for content distribution;

constructing a request to notify the content position information to the server with the position thereof described in the acquisition request;

transmitting the request to the server with the position thereof described in the acquisition request;

receiving a response including a status code indicating a meaning of the response to the request transmitted from the server having received the request;

detecting the response processing rule corresponding to the received response from a rule storage unit for storing a response processing rule defining the correspondence between the information described in the response and selected one of the retransmission of the request and the generation of the content position information as a process after response reception;

generating, as a retransmission destination, a server different from the request transmission destination, and retransmitting the request to the retransmission destination in a case where the detected response processing rule is the retransmission of the request; and

generating the content position information from the information described in the response and transmitting the content position information to the acquisition request transmitter in a case where the detected response processing rule is the generation of the content position information.

According to one aspect of the present invention, there is provided a computer-readable storage medium storing a program which causes a computer to execute the steps of:

receiving an acquisition request for content position information which describes the position of any one of a plurality of servers making up a content distribution network and holding the same content, the content position information indicating the position of the server for content distribution;

constructing a request to notify the content position information to the server with the position thereof described in the acquisition request;

transmitting the request to the server with the position thereof described in the acquisition request;

receiving a response including a status code indicating a meaning of the response to the request transmitted from the server having received the request;

detecting the response processing rule corresponding to the received response from a rule storage unit for storing a response processing rule defining the correspondence between the information described in the response and selected one of the retransmission of the request and the generation of the content position information as a process after response reception;

generating, as a retransmission destination, a server different from the request transmission destination, and retransmitting the request to the retransmission destination in a case where the detected response processing rule is the retransmission of the request; and

generating the content position information from the information described in the response and transmitting the content position information to the acquisition request transmitter in a case where the detected response processing rule is the generation of the content position information.

### BRIEF DESCRIPTION OF THE DRAWINGS

FIG. 1 is a diagram showing a network configuration including a communication apparatus according to a first embodiment;

FIG. 2 is a flowchart for explaining a communication method according to the first embodiment;

FIG. 3 is a sequence diagram for explaining an example of the communication method according to the first embodiment;

FIG. 4 is a sequence diagram for explaining an example of the communication method according to the first embodiment;

FIG. 5 is a diagram showing a network configuration including a communication apparatus according to a second embodiment;

FIG. 6 is a flowchart for explaining a communication method according to the second embodiment;

FIG. 7 is a sequence diagram for explaining an example of the communication method according to the second embodiment;

FIG. 8 is a diagram showing a network configuration including a communication apparatus according to a third embodiment; and

FIG. 9 is a flowchart for explaining a communication method according to the third embodiment.

### DESCRIPTION OF THE PREFERRED EMBODIMENTS

Embodiments of the invention are described below with reference to the drawings.

### First Embodiment

FIG. 1 shows a network configuration including a communication apparatus 100 according to a first embodiment of the invention. An application 10 functions as a part to acquire and view the contents and, based on a predetermined prediction method, predicts the contents selected by the user. The same content as the one predicted by the application 10 is held in a plurality of cache servers 20. In the content distribution network (CDN), the contents are distributed from a cache server suitable for content distribution to the application 10.

Normally, the cache servers 20 on the CDN, whenever accessed, have the HTTP status code in the order of 300 for the accessing party, and transmits a response with the URL of a guide destination (another server) designated in the location header. The other party that has received the response accesses again the URL described in the location header. This is called a redirect operation. By repeating the redirect operation, the client is guided to a cache server suitable for content distribution to the application 10.

The application 10 transmits to the communication apparatus 100 a content position information acquisition request to acquire the information (content position information) specifying the position of the cache server which distributes the predicted content. This content position information acquisition request includes the position (URL) of one of the plurality of the cache servers on the CDN which holds the predicted content. Also, the application 10 holds the content position information acquired by the communication apparatus 100 and uses it at the time of content reproduction.

The communication apparatus 100, based on the content position information acquisition request from the application 10, performs the redirect operation, and by thus specifying the position of the cache server 20 distributing the content, transmits the content position information to the application 10.

The communication apparatus 100 includes a request transmission unit 101, a response receiving unit 102, a response processing rule storage unit 103, a first control unit 110 and a second control unit 120.

The first control unit 110, based on the content position information acquisition request from the application 10 or the processing result of the second control unit 120, constructs a request signal (HTTP request) for requesting the cache server (HTTP server) 20 to notify the content position information.

The request transmission unit 101 transmits the HTTP request constructed by the first control unit 110 to the cache server 20.

The response receiving unit 102 receives from the cache server 20 the HTTP response corresponding to the HTTP request transmitted by the request transmission unit 101. The response receiving unit 102 outputs the received HTTP response to the second control unit 120.

The second control unit 120, by searching the response processing rule storage unit 103, determines the process corresponding to the HTTP response received and executes this process. The second control unit 120 outputs the processing result to the first control unit 110. Also, the second control unit 120 transmits the content position information, if acquired from the processing result of the HTTP response, to the application 10.

The response processing rule storage unit 103 stores the response processing rule indicating a combination of the “condition” of the HTTP response and the “process” executed by the second control unit 120 in the case where the HTTP response coincides with the “condition”.

The status code of the HTTP response or the value of the HTTP header, for example, is described as the “condition”.

An arbitrary process can be registered in the “process”. As the result of the process, however, either the request is retransmitted (the redirect operation is continued or a new request is generated) or the content position information is acquired and transmitted (the redirect operation stopped).

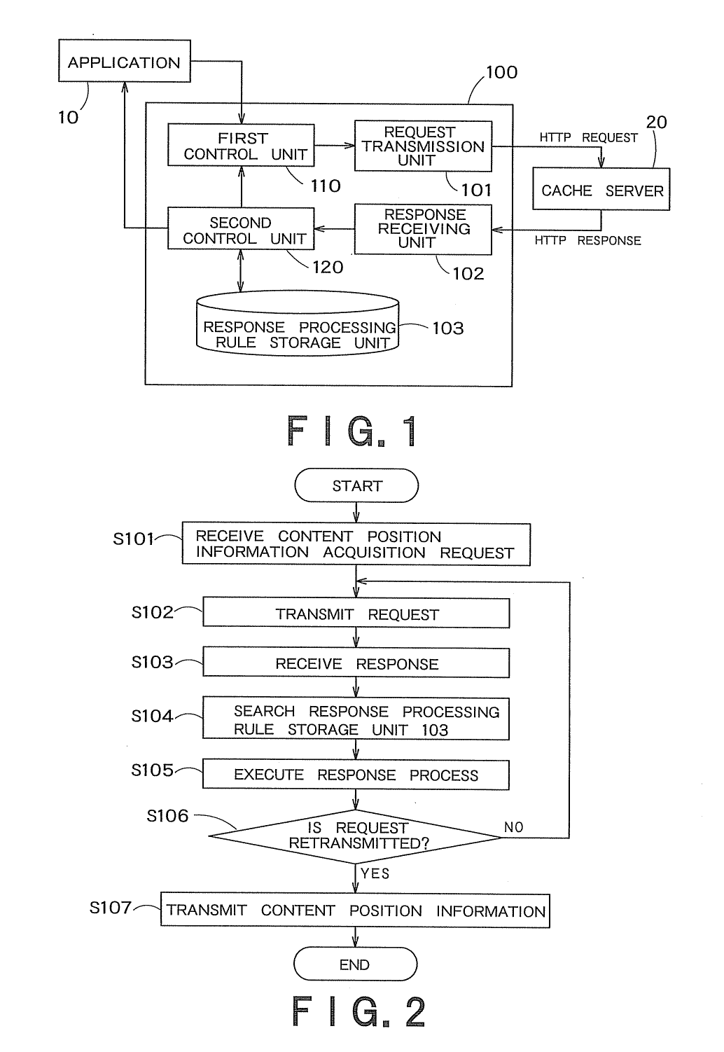

A communication method using this communication apparatus 100 is described with reference to the flowchart shown in FIG. 2.

(Step S101) The application 10 predicts the content selected by the user and transmits the content position information acquisition request for the predicted content. The first control unit 110 receives the content position information acquisition request.
(Step S102) The first control unit 110, based on the content position information acquisition request, constructs the HTTP request, and the request transmission unit 101 transmits the HTTP request to the cache server 20.
(Step S103) The response receiving unit 102 receives the HTTP response from the cache server 20 to the HTTP request transmitted in step S102. The response receiving unit 102 outputs the received HTTP response to the second control unit 120.
(Step S104) The second control unit 120 retrieves that response processing rule stored in the response processing rule storage unit 103 for which the “condition” coincides with the HTTP response received in step S103, and detects the “process” corresponding to the coincident “condition”.

Incidentally, in the case where the coincident “condition” is absent, an error may be notified to the application 10 or the process to be executed may be determined in advance.

(Step S105) The second control unit 120 executes the “process” detected in step S104.
(Step S106) As the result of the process of step S105, whether the request is retransmitted or not is determined. In the case where the request is not retransmitted, the process proceeds to step S107.

In the case where the request is retransmitted (the redirect operation is continued or a new request is generated), on the other hand, the process returns to step S102. At the same time, the second control unit 120 generates the retransmission destination from the response received.

(Step S107) The content position information obtained as the result of the process is transmitted to the application 10.

As described above, according to this embodiment, unlike in the prefetch to acquire the information on the content itself beforehand, only the information specifying the content position is acquired in advance, and therefore, the storage of a large capacity is not required. Also, since the information specifying the content is acquired in advance, the time required before starting the reproduction from the content selection can be shortened.

An example of the response processing rule stored in the response processing rule storage unit 103 is shown in Table 1. In this table, the response processing rule corresponds to the video-sharing site “OOOOO”.

TABLE 1

| | Condition | Process |
|---|---|---|
| Rule 1 | A URL with a | The first control unit 110 is |
| | status code of 303 | requested to retransmit request |
| | and a location | (continue redirect operation) to a |
| | header value | URL designated by the location |
| | including | header. |
| | domainjp.OOOOO.com. | |
| Rule 2 | A status code | Response body is analyzed, and |
| | is 200 and the | in the contents of each script |
| | value of | element appeared, a part of the |
| | content-type | character string subsequent to |
| | header is | “video_id:” coincident with the |
| | text/html. | regular expression |
| | | [symbol] ”video_id [symbol] ”: [symbol] s* [symbol] ”[ [symbol] [symbol] ”]* [symbol] ” are |
| | | extracted as a content ID assigned |
| | | on CDN to identify the content. |
| | | Response body is analyzed, and |
| | | in the contents of each script |
| | | element appeared, a character string |
| | | subsequent to “t:” coincident with |
| | | the regular expression [symbol] ”t [symbol] ”: [symbol] s* [symbol] ”[ [symbol] |
| | | [symbol] ”]* [symbol] ” is extracted as a session ID for |
| | | accessing cache server. |
| | | URL: |
| | | http://www.OOOOO.com/get_video?video_id=<contentID>&t=<sessionID> |
| | | is |
| | | generated using the content ID and |
| | | the session ID. |
| | | With the generated URL as an |
| | | address, the first control unit 110 is |
| | | requested to transmit a new request |
| | | (retransmit request). |
| Rule 3 | A URL with a | A location header value is |
| | status code of 303 | transmitted to an application 10 as a |
| | and a location | URL (content position information) |
| | header value | specifying a content position, and |
| | including | redirect operation is stopped. (No |
| | domaincache.ΔΔΔΔvideo.com. | redirect operation performed upon |
| | | reception of a response having a |
| | | status code 303) |

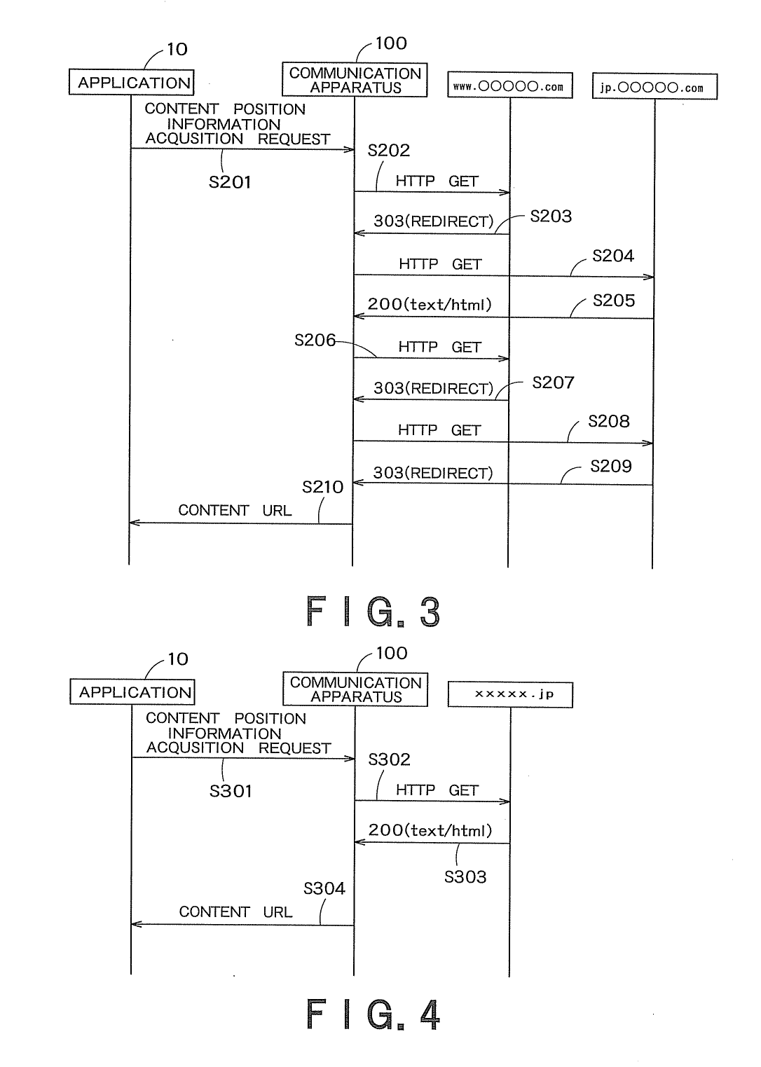

A communication method using the communication apparatus 100 with this response processing rule stored in the response processing rule storage unit 103 is described with reference to the sequence diagram of FIG. 3.

(Step S201) The application 10 transmits the content position information acquisition request including http//www.OOOOO.com/watch?v=vVLATiD0Jzs as the URL of the video viewing page to the first control unit 110 of the communication apparatus 100.
(Step S202) The first control unit 110 constructs the HTTP request addressed to the URL designated in step S201, and the request transmission unit 101 transmits this HTTP request.
(Step S203) The response receiving unit 102 receives the URL having the status code of 303 and including the location header value domainjp.OOOOO.com as the HTTP response, and outputs it to the second control unit 120. The second control unit 120 searches the response processing rule storage unit 103 and detects the coincidence with the rule 1.

The second control unit 120 executes the process corresponding to the rule 1, and requests the first control unit 110 to transmit (request retransmission) the HTTP request addressed to the URL of the location header of the response.

(Step S204) The first control unit 110 constructs the HTTP request addressed to the URL designated in step S203 and the request transmission unit 101 transmits it (continues the redirect operation).
(Step S205). The response receiving unit 102 receives the HTTP response having the HTML-type body with the status code of 200 and text/html as the content-type header value, and outputs it to the second control unit 120.

The second control unit 120 searches the response processing rule storage unit 103 and detects the coincidence with the rule 2.

The second control unit 120 executes the process corresponding to the rule 2, generates a new URL using the session ID and the content ID obtained from the result of analyzing the HTML and requests the first control unit 110 to transmit it (request retransmission).

(Step S206) The first control unit 110 constructs the HTTP request addressed to the URL designated in step S205, and the request transmission unit 101 transmits it (transmits a new request).
(Step S207) The response receiving unit 102 receives the HTTP response constituting the URL including the status code of 303 and domainjp.OOOOO.com as the location header value, and outputs it to the second control unit 120. The second control unit 120 searches the response processing rule storage unit 103 and detects the coincidence with the rule 1.

The second control unit 120 executes the process corresponding to the rule 1 and requests the first control unit 110 to transmit the HTTP request addressed to the URL of the location header of the response.

(Step S208) The first control unit 110 constructs the HTTP request addressed to the URL designated in step S207 and the request transmission unit 101 transmits it (continues the redirect operation).
(Step S209) The request receiving unit 102 receives the response constituting the URL having the status code of 303 and including domaincache.ΔΔΔΔvideo.com as the value of the location header, and outputs it to the second control unit 120. The second control unit 120 searches the response processing rule storage unit 103 and detects the coincidence with the rule 3. The second control unit 120 executes the process corresponding to the rule 3.
(Step S210) As the result of executing the process corresponding to the rule 3 in step S209, the second control unit 120 transmits the value of the location header of the response to the application 10 as the URL (content position information) specifying the position of the content (stops the redirect operation).

Another example of the response processing rule stored in the response processing rule storage unit 103 is shown in Table 2. In this table, the response processing rule corresponds to the video-sharing site “xxxxx”.

TABLE 2

| | Condition | Process |
|---|---|---|
| Rule 1 | A status code is | A HTML text of a response |
| | 200, and a | body is analyzed to acquire an src |
| | content-type header | attribute value of an img element |
| | value is text/html. | as a child element of the a |
| | | element as the child element of a |
| | | p element with class attribute |
| | | movieText as a child element of a |
| | | div element as a child element of |
| | | the div element of content as |
| | | class attribute. |
| | | The portion vi of host name |
| | | of URL acquired is changed to vm, |
| | | and /jpg/ immediately after |
| | | domain name changed to /flv/. A |
| | | URL of which portion coincident |
| | | with the regular expression |
| | | [0-9]+ [symbol] .jpg in file name is |
| | | replaced by .flv is returned as |
| | | content position information. |

The communication method using the communication apparatus 100 with this response processing rule stored in the response processing rule storage unit 103 is described with reference to the sequence shown in FIG. 4.

(Step S301) The application 10 transmits the content position information acquisition request including http://xxxxx.jp/watch.do?movie=1103949 as URL of the video viewing page to the first control unit 110 of the communication apparatus 100.
(Step S302) The first control unit 110 constructs the HTTP request addressed to URL designated in step S301 and the request transmission unit 101 transmits it.
(Step S303) The response receiving unit 102 receives the HTTP response having the status code of 200 and “text/html” as the value of the content-type header and outputs it to the second control unit 120.

The second control unit 120 searches the response processing rule storage unit 103 and detects that the response received is coincident with the rule 1. The second control unit 120 executes the process corresponding to the rule 1.

(Step S304) As the result of executing the process corresponding to the rule 1 in step S303, the second control unit 120 transmits the value of the location header of the response to the application 10 as the URL (content position information) specifying the content position (stops the redirect operation).

The contents, if viewed without specifying the content position in advance, are distributed after being guided to the cache server by the redirect operation. In a large-scale CDN, the guidance to the cache server requires about 1.5 to 2.0 seconds.

According to this embodiment, this time can be saved since the information specifying the content position is acquired before starting the content reproduction, and therefore, so that the time required for redirect operation is shortened while at the same time reducing the delay before starting the reproduction after selecting the content.

Also, the information specifying the content position (content position information) is very small in capacity as compared with a part or the whole of the content itself. Even in the case where the content position information for a large amount of contents is acquired, therefore, a large capacity of storage is not required.

The content position information can be expressed by the text information such as URL in many cases. With at most 1024 bytes, therefore, a sufficient capacity is secured to store most URLs. The data size of the video contents is varied depending on the resolution of the video, the frame rate, the bit rate, etc. and therefore, cannot be determined directly. Nevertheless, 1024 bytes is not a sufficient capacity as a cache.

The acquisition of the URL (content position information) alone consumes the memory capacity less than the acquisition of a part of the content. Thus, the delay in content reproduction can be shortened sufficiently using a part of the memory of a home electric appliance.

According to the first embodiment described above, the application 10 and the communication apparatus 100 may be either located in the same terminal unit or divided into different terminals units connected through a network. In the case where the application 10 and the communication apparatus 100 are divided into different terminal units, the content position information acquisition request may be transmitted with an arbitrary communication protocol.

The application 10 may designate the HTTP method of the request transmitted by the request transmission unit 101.

Also, the application 10 may designate a plurality of HTTP headers and the values thereof inserted in the request transmitted by the request transmission unit 101.

Further, the application 10 may designate the data inserted in the body of the request (post) transmitted by the request transmission unit 101.

Furthermore, the application 10 may directly designate, with the URL, the destination of the request transmitted by the request transmission unit 101, or designate only the information required for the request transmission unit 101 to determine the destination.

The second control unit 120 may be equipped with an environment for executing a matching rule stored in the response processing rule storage unit 103, and may execute the rule to match the response and the rule with each other and thereby to judge whether they so match or not.

The “condition” of the response processing rule storage unit 103 may be a segment or the whole of a program described in an arbitrary programming language.

Also, a segment or the whole of the execution code described in an arbitrary programming language and converted by a processing system may be stored in the “condition”.

Further, the response processing rule storage unit 103 may store the information specifying the processing system for executing the “process”. Furthermore, the ID for identifying the processing system or the execution address on the memory of the processing system may be stored in it.

### Second Embodiment

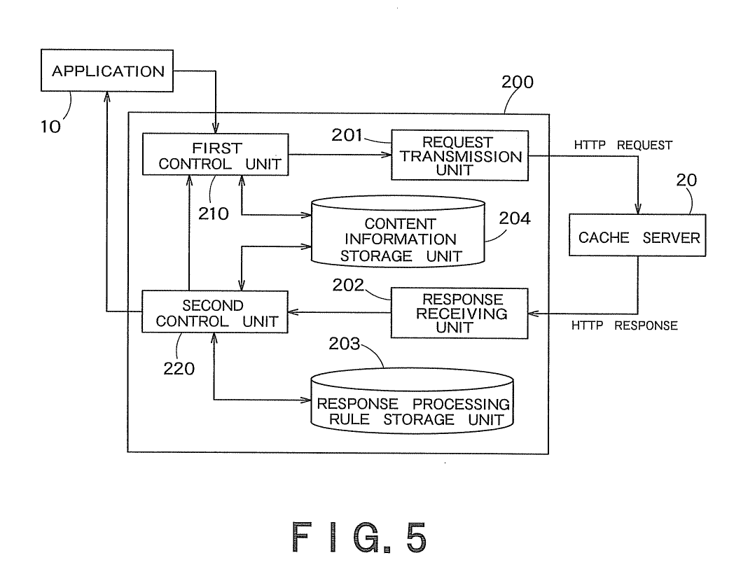

FIG. 5 shows a network configuration including a communication apparatus 200 according to a second embodiment of the invention. The communication apparatus 200 includes a request transmission unit 201, a response receiving unit 202, a response processing rule storage unit 203, a content information storage unit 204, a first control unit 210 and a second control unit 220.

The content information storage unit 204 stores a “content identifier” and a “connection identifier”. The “content identifier” represents the information for identifying the content in the state waiting for the HTTP response to the HTTP request transmitted to the server on the CDN (content distribution network). The URL capable of uniquely identifying the content or the ID assigned to the content by the CDN, for example, is used as the “content identifier”.

The “connection identifier” represents the information for identifying the connection (TCP connection) established with the server on the CDN to transmit the HTTP request and receive the HTTP response.

The first control unit 210 is similar to the first control unit 110 of the first embodiment except that in the first control unit 210, the data is registered (new data is generated) in the content information storage unit 204 based on the content position information acquisition request and the data of the content information storage unit 204 is updated based on the HTTP request transmitted.

The second control unit 220 is similar to the second control unit 120 of the first embodiment except that the second control unit 220, based on the information for identifying the connection having received the HTTP response, searches the content information storage unit 204, detects the transmission destination of the HTTP request corresponding to the received HTTP response and searches the response processing rule storage unit 203 using the detected transmission destination.

The response processing rule storage unit 203, like the response processing rule storage unit 103 of the first embodiment, stores the response processing rule indicating a combination of the “condition” of the HTTP response and the “process” executed by the response receiving unit 202 in the case where the HTTP response coincides with the “condition”.

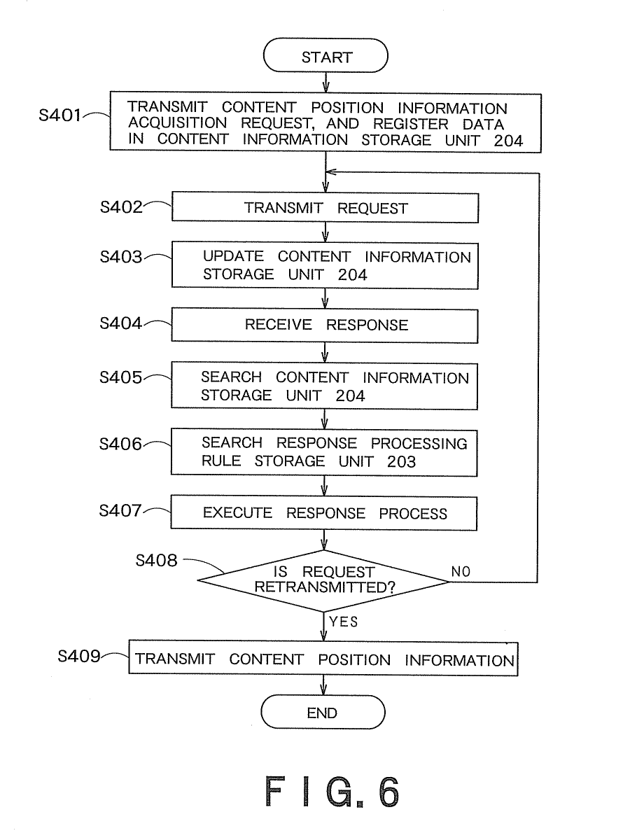

A communication method using this communication apparatus 200 is described with reference to the flowchart of FIG. 6.

(Step S401) The application 10 predicts the content acquired in advance and transmits the content position information acquisition request to the first control unit 210. The first control unit 210 registers the data corresponding to the content position information acquisition request in the content information storage unit 204.
(Step S402) The first control unit 210 constructs the HTTP request based on the content position information acquisition request, and the request transmission unit 201 transmits it to the cache server 20.
(Step S403) The first control unit 210, with the transmission of the HTTP request from the request transmission unit 201, updates the data of the content information storage unit 204.
(Step S404) The response receiving unit 202 receives the HTTP response from the cache server 20 to the HTTP request transmitted in step S402, and outputs it to the second control unit 220.
(Step S405) The second control unit 220 searches the content information storage unit 204 using the TCP connection identification information for identifying the TCP connection having received the HTTP response, and detects the destination of the HTTP request transmitted in step S402.
(Step S406) The second control unit 220, using the transmission destination of the HTTP request detected in step S405, retrieves that response processing rule stored in the response processing rule storage unit 203 for which the “condition” coincides with the HTTP response received in step S404, and detects the “process” corresponding to the coincident “condition”.

Incidentally, in the absence of a coincident “condition”, an error may be notified to the application 10 or the process to be executed may be determined in advance.

(Step S407) The second control unit 220 executes the “process” detected in step S406.
(Step S408) As the result of executing the process of step S407, whether the request is to be retransmitted or not is determined. In the case where the request is not retransmitted, the process proceeds to step S409.

In the case where the request is retransmitted (the redirect operation is continued or a new request is generated), on the other hand, the process returns to step S402. In the process, the second control unit 220 generates the retransmission destination from the response received.

(Step S409) The content position information obtained as the result of the process execution is transmitted to the application 10.

As described above, according to this embodiment, unlike in the prefetch function to acquire the information on the content itself in advance, only the information specifying the content position is acquired in advance, and therefore, the storage of a large capacity is not required. Also, by acquiring the information specifying the content position in advance, the time required from content selection and reproduction start can be shortened.

The content position information for one service (video-sharing site) is acquired according to the first embodiment. According to the present embodiment, equipped with the content information storage unit 204, on the other hand, a particular service corresponding to the HTTP response can be identified, and therefore, the content position information can be acquired for a plurality of services.

An example of the response processing rule stored in the response processing rule storage unit 203 is shown in Table 3. In this table, the response processing rule corresponds to the video-sharing sites “OOOOO” and “xxxxx”.

TABLE 3

| | Condition | Process |
|---|---|---|
| Rule 1 | A request | The first control unit 210 is |
| | transmission | requested to retransmit request |
| | destination URL | (continue redirect operation) to a |
| | includes domain | URL designated by the location |
| | OOOOO.com, a | header. |
| | response status | |
| | code 303 and a | |
| | location header | |
| | value | |
| | domainjp.OOOOO.com. | |
| Rule 2 | A request | A response body is analyzed, |
| | transmission | and in the content of each script |
| | destination URL | element that has appeared, a |
| | includes domain | character string including and |
| | OOOOO.com, a | subsequent to “video_id:” in the |
| | response status | character string coinciding with the |
| | code 200, and a | regular expression |
| | content-type | [symbol] ”video_id [symbol] ”: [symbol] s* [symbol] ”[ [symbol] [symbol] ”]* [symbol] ” is |
| | header value | extracted as a content ID assigned |
| | text/html. | on CDN to identify the content. |
| | | A response body is analyzed, |
| | | and in the content of each script |
| | | element that has appeared, a |
| | | character string including and |
| | | subsequent to “t:” in the character |
| | | string coinciding with the regular |
| | | expression [symbol] ”t [symbol] ”: [symbol] s* [symbol] ”[ [symbol] [symbol] ”]* [symbol] ” is |
| | | extracted as a session ID to access |
| | | cache server. |
| | | URL |
| | | http://www.OOOOO.com/get_video?video_id=<contentID>&t=<sessionID> |
| | | is generated using the content ID |
| | | and the session ID. |
| | | Request transmission unit 201 |
| | | is requested to transmit a new |
| | | request (request retransmission) |
| | | with the generated URL as an |
| | | address. |
| Rule 3 | A request | A location header value is |
| | transmission | transmitted to an application 10 as |
| | destination URL | a URL (content position |
| | includes domain | information) specifying a content |
| | OOOOO.com, a | position, and redirect operation is |
| | response status | stopped. (A response with a status |
| | code 303, and a | code of 303, if received, is not |
| | location header | redirected) |
| | value | |
| | domaincache.ΔΔΔΔ.video.com. | |
| Rule 4 | A request | A HTML text of a response |
| | transmission | body is analyzed thereby to acquire |
| | destination URL | an src attribute of an img element |
| | includes | as a child element of the a element |
| | domainxxxx.jp, a | of the child element of a p element |
| | response status | of movieText with class attribute as |
| | code 200, and a | a child element of a div element of |
| | content-type | a child element of the div element |
| | header value | of content as class element. |
| | text/html. | A host name portion vi of |
| | | acquired URL is changed to vm, and |
| | | /jpg/ immediately after a domain |
| | | name changed to /flv/. URL in |
| | | which a file name portion coincident |
| | | with the regular expression |
| | | [0-9]+ [symbol] .jpg is replaced by .flv is |
| | | transmitted to an application 10 as |
| | | content position information. |

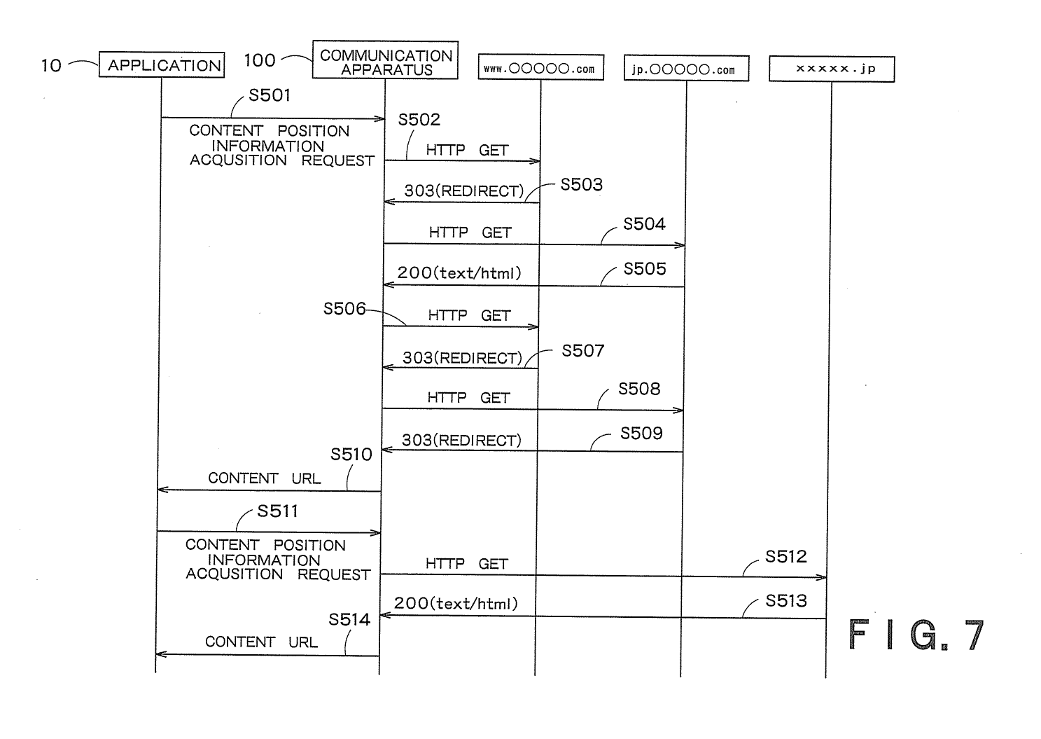

The communication method using the communication apparatus 200 with this response processing rule stored in the response processing rule storage unit 203 is described with reference to the sequence shown in FIG. 7.

(Step S501) The application 10 transmits the content position information acquisition request including http://www.OOOOO.com/watch?v=vVLATiD0Jzs as URL of the video viewing page to the first control unit 210 of the communication apparatus 200.
(Step S502) The first control unit 210 stores (registers), in the content information storage unit 204, the information for identifying the TCP connection to transmit the HTTP request as a “connection identifier”, the URL designated in step S501 as a “content identifier” and the URL of the request transmission destination (identical with the URL designated in step S501 in the case under consideration).

Then, the first control unit 210 constructs the HTTP request addressed to the URL designated in step S501, and the request transmission unit 201 transmits it.

(Step S503) The response receiving unit 502 receives the HTTP response with the status code of 303 and the location header value as the URL including domainjp.OOOOO.com, and outputs it to the second control unit 220.

The second control unit 220, based on the information indicating the TCP connection having received the HTTP response, searches the content information storage unit 204, and acquires the transmission destination URL of the HTTP request corresponding to the HTTP response.

Further, the second control unit 220, using the request transmission destination URL obtained by searching the content information storage unit 204, searches the response processing rule storage unit 203 and detects that the received HTTP response coincides with the rule 1.

The second control unit 220 executes the process corresponding to the rule 1, and requests the first control unit 210 to transmit the HTTP request with the URL in the response location header as an address.

(Step S504) The first control unit 210 constructs the HTTP request addressed to the URL designated in step S503, and the request transmission unit 201 transmits it (continues the redirect operation).

Then, the first control unit 210 updates the request transmission destination URL (“content identifier”) stored in the content information storage unit 204 to the URL designated in step S503. The information for identifying the connection (“connection identifier”) is also updated.

(Step S505) The response receiving unit 202 receives the HTTP response having the body of a HTML form with the status code 200 and the content-type header value text/html, and outputs it to the second control unit 220.

The second control unit 220, based on the information indicating the TCP connection having received the HTTP response, searches the content information storage unit 204 and acquires the transmission destination URL of the HTTP request corresponding to the HTTP response.

Then, the second control unit 220, using the request transmission destination URL obtained by searching the content information storage unit 204, searches the response processing rule storage unit 203 and detects that the received HTTP response coincides with the rule 2.

The second control unit 220 executes the process corresponding to the rule 2, and by generating a new URL using the content ID and, the session ID obtained from the result of analyzing the HTML, requests the first control unit 210 to transmit the request.

(Step S506) The first control unit 210 constructs the HTTP request addressed to the URL designated in step S505, and the request transmission unit 201 transmits it (transmits a new request).

Further, the second control unit 220 updates the request transmission destination URL (“content identifier”) of the content information storage unit 204 and the connection identification information (“connection identifier”).

(Step S507) The response receiving unit 202 receives the HTTP response as the URL including the status code 303 and the location header value domainjp.OOOOO.com, and outputs it to the second control unit 220.

The second control unit 220, based on the information indicating the TCP connection having received the HTTP response, searches the content information storage unit 204 and acquires the transmission destination URL of the HTTP request corresponding to the HTTP response.

Then, the second control unit 220, using the request transmission destination URL obtained by searching the content information storage unit 204, searches the response processing rule storage unit 203 and detects that the received HTTP response coincides with the rule 1.

The second control unit 220 executes the process corresponding to the rule 1, and requests the first control unit 210 to transmit the HTTP request addressed to the URL of the response location header.

(Step S508) The first control unit 210 constructs the HTTP request addressed to the URL designated in step S507, and the request transmission unit 201 transmits it (continues the redirect operation).

Further, the first control unit 210 updates the request transmission destination URL of the content information storage unit 204 and the connection identification information.

(Step S509) The request receiving unit 202 receives the response having the status code 303 and the location header value as a URL including domaincache.ΔΔΔΔvideo.com, and outputs it to the second control unit 220.

The second control unit 220, based on the information indicating the TCP connection having received the HTTP response, searches the content information storage unit 204, and acquires the destination URL of the HTTP request corresponding to the HTTP response.

Then, the second control unit 220, using the request transmission destination URL obtained by searching the content information storage unit 204, searches the response processing rule storage unit 203 and detects that the received HTTP response coincides with the rule 3.

The second control unit 220 executes the process corresponding to the rule 3.

(Step S510) The second control unit 220, as the result of executing the process corresponding to the rule 3 in step S509, transmits the location header value to the application 10 as the URL (content position information) specifying the content position (stops the redirect operation).
(Step S511) The application 10 transmits the content position information acquisition request including http://xxxxx.jp/watch.do?movie=1103949 as the URL of the video viewing page to the first control unit 210 of the communication apparatus 200.
(Step S512) The first control unit 210 stores, in the content information storage unit 204, the information for identifying the TCP connection for transmitting the HTTP request as the “connection identifier”, the URL designated in step S511 as the “content identifier” and the URL of the request transmission destination (in this case, identical with the URL designated in step S511).

Then, the second control unit 220 constructs the HTTP request addressed to the URL designated in step S511, and the request transmission unit 201 transmits it.

(Step S513) The response receiving unit 202 receives the HTTP response having the status code 200 and the content-type header value “text/html”, and outputs it to the second control unit 220.

The second control unit 220, based on the information indicating the TCP connection having received the HTTP response, searches the content information storage unit 204, and acquires the destination URL of the HTTP request corresponding to the HTTP response.

The second control unit 220, using the request transmission destination URL obtained by searching the content information storage unit 204, searches the response processing rule storage unit 203 and detects that the received HTTP response coincides with the rule 4.

The second control unit 220 executes the process corresponding to the rule 4.

(Step S514) The second control unit 220, as the result of executing the process corresponding to the rule 4 in step S513, transmits the location header value of the response to the application 10 as the URL (content position information) specifying the content position (stops the redirect operation).

As described above, also according to this embodiment, like in the first embodiment described above, the information specifying the content position is obtained before starting the content reproduction, and therefore, the delay from content selection to reproduction start can be shortened.

Also, the information (content position information) specifying the content position is very small in capacity as compared with a part or the whole of the content itself. Even in the case where the content position information for a large amount of contents is acquired, therefore, the storage of a large capacity is not required.

Further, by identifying the transmission destination URL of the HTTP request from the connection identification information of the HTTP response, the content position information can be acquired in advance for a plurality of video-sharing services.

According to the second embodiment described above, the content information storage unit 204 may hold the transmission destination URL of the finally transmitted HTTP request or the finally transmitted HTTP request itself.

Also, the content information storage unit 204 may hold all the HTTP requests and the HTTP responses.

According to the second embodiment described above, the content information including the “content identifier” and the “connection identifier” is stored in the content information storage unit 204 and the response processing rule in the response processing rule storage unit 203. Nevertheless, the response processing rule may also be stored in the content information storage unit 204.

In this case, the application 10, while transmitting the content position information acquisition request (content URL), also transmits the rule for processing the response to the request transmitted from the request transmission unit 201 at the same time.

The response processing rule is registered in the content information storage unit 204, by the first control unit 210, together with the information for identifying the TCP connection for transmitting the HTTP request, the URL designated from the application 10 and the URL of the request transmission destination (identical with the URL designated from the application 10).

### Third Embodiment

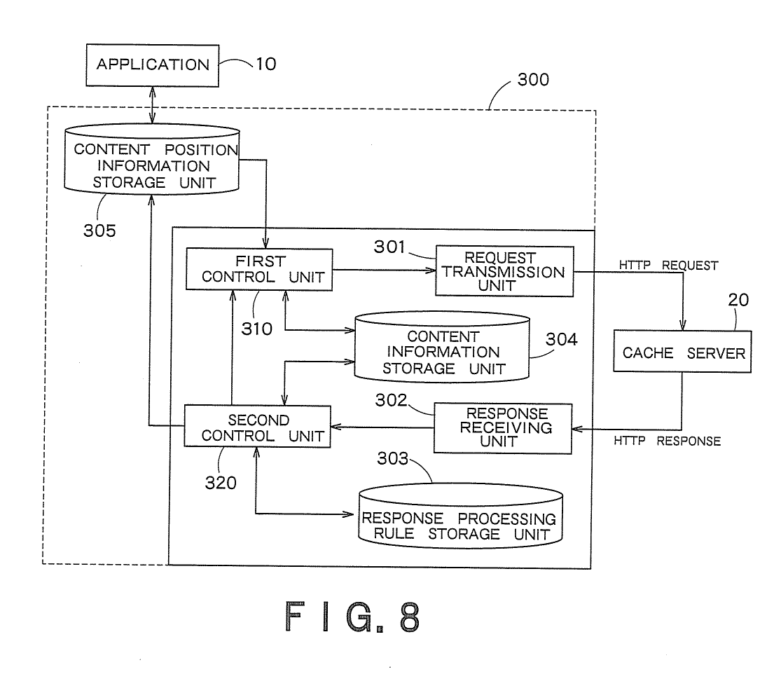

FIG. 8 shows a network configuration including a communication apparatus 300 according to a third embodiment of the invention. The communication apparatus 300 has a configuration similar to the configuration of the communication apparatus 200 according to the second embodiment shown in FIG. 5, except that the communication apparatus 300 has a content position information storage unit 305.

The content position information storage unit 305 stores, in combination, information for uniquely identifying the content (URL, the ID assigned by the CDN to the content, etc.), the information specifying the content position (URL, IP address, etc.) and the deadline of the information specifying the content position. In the case where the information other than the information (URL) specifying the content position is required to access the content, it is also stored.

The content information storage unit 305 may be located in the same terminal unit as the communication apparatus 300 or may be divided into different terminal units connected through a network. In the case where the content information storage unit 305 is divided into different terminal units, the content position information acquisition request may be transmitted by an arbitrary communication protocol. The content position information storage unit 305 is formed of a cache memory, for example.

The content position information storage unit 305 receives the content position information acquisition request transmitted from the application 10, and in the case where the content position information before the deadline corresponding to the particular request is stored therein, transmits the particular content position information to the application 10.

The content position information storage unit 305, in the case where the content position information before the deadline corresponding to the content position information acquisition request is not stored therein, on the other hand, transmits the content position information acquisition request to a first control unit 310.

The functions of a request transmission unit 301, a response receiving unit 302, a response processing rule storage unit 303, a content information storage unit 304, the first control unit 310 and a second control unit 320 are similar to those of the second embodiment described above, and therefore, the description thereof will not repeated.

The second control unit 320 transmits the content position information obtained as the result of the process to the content position information storage unit 305. The content position information storage unit 305 stores the received content position information on the one hand and transmits it to the application 10 on the other hand.

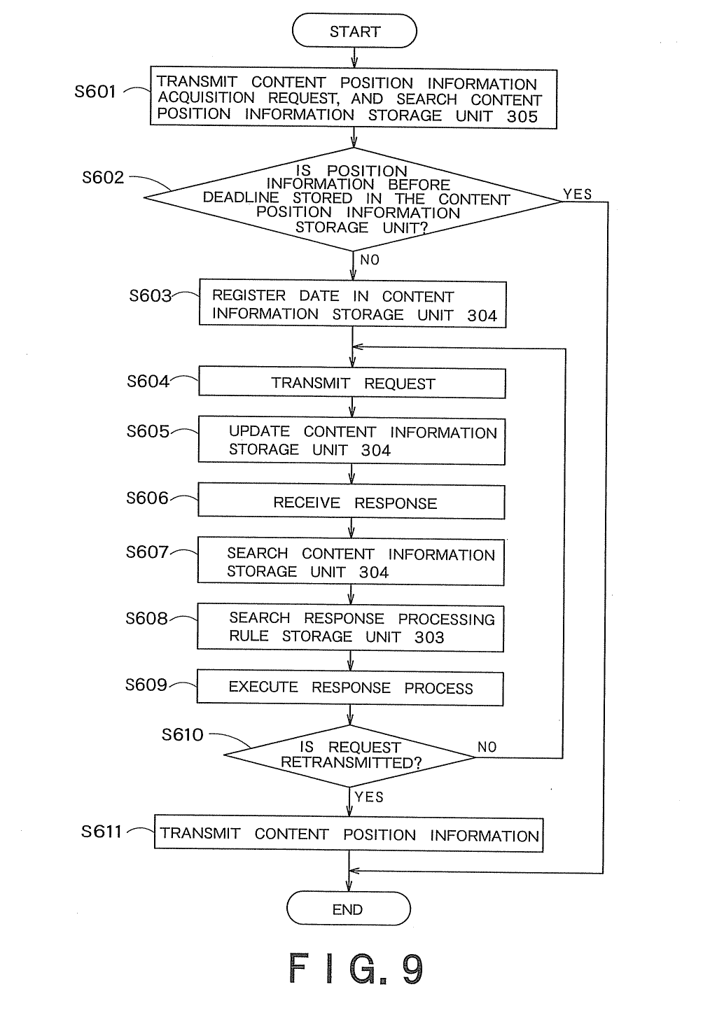

The communication method using this communication apparatus 300 is described with reference to the flowchart shown in FIG. 9.

(Step S601) The application 10 transmits the content position information acquisition request. Upon reception of the content position information acquisition request, the content position information storage unit 305 is searched.
(Step S602) In the case where the content position information before the deadline is stored in the content position information storage unit 305 to meet the content position information acquisition request, the particular content position information is transmitted to the application 10 thereby to end the process.

In the case where the content position information before the deadline is not stored in the content position information storage unit 305 to meet the content position information acquisition request, on the other hand, the content position information acquisition request is transmitted to the first control unit 310 and the process proceeds to step S603.

(Step S603) The first control unit 310 registers the data corresponding to the content position information acquisition request in the content information storage unit 304.
(Step S604) The first control unit 310 constructs the HTTP request addressed to the URL contained in the content position information acquisition request, and the request transmission unit 301 transmits it.
(Step S605) The first control unit 310, upon transmission of the HTTP request by the request transmission unit 301, updates the data of the content information storage unit 304.
(Step S606) The response receiving unit 302 receives the HTTP response from the cache server 20 as a response to the HTTP request transmitted in step S604, and outputs it to the second control unit 320.
(Step S607) The second control unit 320, using the TCP connection identification information for identifying the TCP connection having received the HTTP response, searches the content information storage unit 304 and detects the transmission destination of the HTTP request transmitted in step S604.
(Step S608) The second control unit 320, using the transmission destination detected in step S607, retrieves that response processing rule stored in the response processing rule storage unit 303 of which the “condition” coincides with the HTTP response received in step S606, and detects the “process” corresponding to the coincident “condition”.

Incidentally, in the absence of the coincident “condition”, an error may be notified to the application 10 or the process to be executed may be determined in advance.

(Step S609) The second control unit 320 executes the “process” detected in step S608.
(Step S610) As the result of process executed in step S609, whether the request is to be retransmitted or not is determined. In the case where the request is not retransmitted, the process proceeds to step S611. In the case where the request is retransmitted (the redirect operation is continued or a new request is generated), on the other hand, the process returns to step S604.
(Step S611) The content position information obtained as the result of the process execution is transmitted to the content position information storage unit 305. The content position information storage unit 305 registers (updates) the data using the content position information received, and transmits the content position information to the application 10.

As described above, according to this embodiment, like in the first and second embodiments, the information specifying the content position is acquired before content reproduction, and therefore, the delay from content selection to reproduction start is shortened.

Also, the information specifying the content position (content position information) is very small in capacity as compared with a part or the whole of the content itself. Even in the case where the content position information for a great amount of contents is acquired, therefore, the storage of a large capacity is not required.

As the result of the provision of the content position information storage unit 305, neither the request is transmitted nor the response is received for the content for which the content position information has already been acquired, and the content position information is retrieved from the content position information storage unit 305 and is returned to the application 10. Thus, the application 10 can acquire the content position information for a great amount of contents in a short time.

According to the third embodiment described above, that content position information stored in the content position information storage unit 305 for which the content approaches the deadline may be acquired again and the data of the content position information storage unit 305 may be updated.

The first to third embodiments are described above with reference to a case in which the “condition” of one response processing rule coincides with one response. Nevertheless, the “condition” of a plurality of response processing rules may coincide with one response. In such a case, the response receiving units 102, 202, and 302 execute the process corresponding to a plurality of rules in parallel.

In the process, the content information storage units 204, 304 and the content position information storage unit 305 duplicate an entry each time the “condition” of the response processing rule is coincident. Also, the content position information storage unit 305, upon reception of the content position information acquisition request from the application 10, returns a plurality of position information. Also, the content position information storage unit 305 manages the deadlines of the entries individually.

According to the embodiments described above, the content selected by the user can be predicted by the application 10 from the viewing history or the taste information. Also, the content position information for all the contents displayed on the top page of the video-sharing site may be acquired.

At least part of the communication apparatus described in the above embodiments may be implemented in either hardware or software. When implemented in software, a program that realizes at least part of functions of the communication apparatus may be stored on a recording medium such as a flexible disk or CD-ROM and read and executed by a computer. The recording medium is not limited to a removable recording medium such as a magnetic disk or optical disk, but may be a non-removable recording medium such as a hard disk device or memory.

The program that realizes at least part of the functions of the communication apparatus may be distributed through a communication line (including wireless communications) such as the Internet. Further, the program may be encrypted, modulated, or compressed to be distributed through a wired line or wireless line such as the Internet or to be distributed by storing the program on a recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a first control unit configured to receive an acquisition request for content position information which describes the position of any one of a plurality of servers making up a content distribution network and holding the same content, the content position information indicating the position of a server distributing the content, and construct a request to notify the content position information to the server with the position thereof described in the acquisition request;
a request transmission unit configured to transmit the request constructed by the first control unit to the server with the position thereof described in the acquisition request;
a response receiving unit configured to receive a response including a status code which indicates a meaning of the response to the request transmitted from the server;
a rule storage unit configured to store a response processing rule specifying the correspondence between information described in the response and selected one of the retransmission of the request and the generation of the content position information as a process after response reception; and
a second control unit configured to detect, from the rule storage unit, a response processing rule corresponding to the information described in the response received by the response receiving unit, and in a case where the detected response processing rule is the retransmission of the request, notify the first control unit of selected one of a retransmission request for the request generated with a server different from the transmission destination as a retransmission destination and a retransmission request for the request carrying a different parameter for the same server as the transmission destination, while in a case where the detected response processing rule is the generation of the content position information, on the other hand, generate the content position information from the information described in the response and transmit the content position information to the transmitter of the acquisition request.

2. The apparatus according to claim 1,
wherein the second control unit notifies the first control unit of the position of the server described as the retransmission destination in the header of the received response in a case where the detected response processing rule is the retransmission of the request,
the first control unit constructs a request to the retransmission destination based on the notification from the second control unit, and
the request transmission unit transmits the request constructed by the first control unit to the retransmission destination.

3. The apparatus according to claim 1,
wherein in a case where the detected response processing rule is the retransmission of the request, the second control unit analyzes the body of the received response and by generating the retransmission destination using the character string obtained by the analysis, notifies the first control unit,
the first control unit constructs a request to the retransmission destination based on the notification from the second control unit, and
the request transmission unit transmits the request constructed by the first control unit to the retransmission destination.

4. The apparatus according to claim 1, further comprising a content information storage unit configured to store the request retransmission destination and the connection identification information for identifying the connection having transmitted the request,
wherein the first control unit outputs the request transmission destination and the connection identification information to the content information storage unit based on the acquisition request,
the response receiving unit outputs to the second control unit the connection identification information of the connection having received the response, and
the second control unit searches the content information storage unit using the connection identification information notified from the response receiving unit, and by detecting the request transmission destination corresponding to the response, detects the response processing rule from the rule storage unit using the detected transmission destination.

5. The apparatus according to claim 4,
wherein the first control unit constructs a second request to the retransmission destination based on the notification from the second control unit, and
with the transmission of the second request by the request transmission unit, the transmission destination and the connection identification information stored in the content information storage unit are updated, by the first control unit, into the retransmission destination and the connection identification information for identifying the connection that has transmitted the second request.

6. The apparatus according to claim 4,
wherein the second control unit notifies the first control unit of the position of the server described as the retransmission destination in the header of the received response in a case where the detected response processing rule is the retransmission of the request,
the first control unit constructs a second request to the retransmission destination based on the notification from the second control unit, and
with the transmission of the second request by the request transmission unit, the transmission destination and the connection identification information stored in the content information storage unit are updated, by the first control unit, into the retransmission destination and the connection identification information for identifying the connection that has transmitted the second request.

7. The apparatus according to claim 4,
wherein in a case where the detected response processing rule is the retransmission of the request, the second control unit analyzes the body of the received response and by generating the retransmission destination using the character string obtained by the analysis, notifies the first control unit,
the first control unit constructs a second request to the retransmission destination based on the notification from the second control unit, and
with the transmission of the second request by the request transmission unit, the transmission destination and the connection identification information stored in the content information storage unit are updated, by the first control unit, into the retransmission destination and the connection identification information for identifying the connection that has transmitted the second request.

8. The apparatus according to claim 1,
wherein the second control unit transmits by acquiring the deadline of the content position information together with the content position information from the received response,
the communication apparatus further comprising a content position information storage unit for storing the content position information and the deadline transmitted from the second control unit, and
wherein the content position information storage unit receives the acquisition request, and in a case where the content position information before the deadline corresponding to the acquisition request is stored, transmits the content position information to the transmitter of the acquisition request, while in a case where the content position information before the deadline corresponding to the acquisition request is not stored, on the other hand, transmits the acquisition request to the first control unit.

9. The apparatus according to claim 8,
wherein the second control unit notifies the first control unit of the position of the server described as the retransmission destination in the header of the received response in a case where the detected response processing rule is the retransmission of the request,
the first control unit constructs a request to the retransmission destination based on the notification from the second control unit, and
the request transmission unit transmits the request constructed by the first control unit to the retransmission destination.

10. The apparatus according to claim 8,
wherein in a case where the detected response processing rule is the retransmission of the request, the second control unit analyzes the body of the received response and by generating the retransmission destination using the character string obtained by the analysis, notifies the first control unit,
the first control unit constructs a request to the retransmission destination based on the notification from the second control unit, and
the request transmission unit transmits the request constructed by the first control unit to the retransmission destination.

11. The apparatus according to claim 1, further comprising an application for predicting the content viewed by the user, transmitting the acquisition request for the content position information on the predicted content to the first control unit, and receiving the content position information transmitted from the second control unit.

12. A communication method comprising:
receiving an acquisition request for content position information which describes the position of any one of a plurality of servers making up a content distribution network and holding the same content, the content position information indicating the position of the server for content distribution;
constructing a request to notify the content position information to the server with the position thereof described in the acquisition request;
transmitting the request to the server with the position thereof described in the acquisition request;
receiving a response including a status code indicating a meaning of the response to the request transmitted from the server having received the request;
detecting the response processing rule corresponding to the received response from a rule storage unit for storing a response processing rule defining the correspondence between the information described in the response and selected one of the retransmission of the request and the generation of the content position information as a process after response reception;
generating, as a retransmission destination, a server different from the request transmission destination, and retransmitting the request to the retransmission destination in a case where the detected response processing rule is the retransmission of the request; and
generating the content position information from the information described in the response and transmitting the content position information to the acquisition request transmitter in a case where the detected response processing rule is the generation of the content position information.

13. A computer-readable storage medium storing a program which causes a computer to execute the steps of:
receiving an acquisition request for content position information which describes the position of any one of a plurality of servers making up a content distribution network and holding the same content, the content position information indicating the position of the server for content distribution;
constructing a request to notify the content position information to the server with the position thereof described in the acquisition request;
transmitting the request to the server with the position thereof described in the acquisition request;
receiving a response including a status code indicating a meaning of the response to the request transmitted from the server having received the request;
detecting the response processing rule corresponding to the received response from a rule storage unit for storing a response processing rule defining the correspondence between the information described in the response and selected one of the retransmission of the request and the generation of the content position information as a process after response reception;
generating, as a retransmission destination, a server different from the request transmission destination, and retransmitting the request to the retransmission destination in a case where the detected response processing rule is the retransmission of the request; and
generating the content position information from the information described in the response and transmitting the content position information to the acquisition request transmitter in a case where the detected response processing rule is the generation of the content position information.
